(19) United States
(12) Patent Application Publication
(10) Pub. No.: US 2014/0244298 A1
(43) Pub. Date: Aug. 28, 2014

(54) ELECTRONIC ROOM SIGN FOR HEALTHCARE INFORMATION TECHNOLOGY SYSTEM

(71) Applicant: Hill-Rom Services, Inc., Batesville, IN (US)

(72) Inventors: Andrew S. Robinson, Durham, SC (US); Dino R. Bostic, Cary, NC (US); William B. Bishop, Apex, NC (US); Matthew D. Morgan, Cary, NC (US); David M. Girardeau, Pittsboro, NC (US); Joshua P. Lingenfelser, Fuquay Varina, NC (US); Bradley T. Smith, Raleigh, NC (US)

(73) Assignee: Hill-Rom Services, Inc., Batesville, IN (US)

(21) Appl. No.: 14/185,976

(22) Filed: Feb. 21, 2014

Related U.S. Application Data
(60) Provisional application No. 61/770,528, filed on Feb. 28, 2013.

(51) Int. Cl. G06F 19/00

(52) U.S. Cl. CPC G06F 19/322
USPC 705/3

(57) ABSTRACT

An electronic room sign system is provided for use in a healthcare information technology system that includes an electronic medical records (EMR) system and a real time locating system (RTLS). The electronic room sign system includes a display mounted adjacent a doorway of a room of a patient and a server signaling the display to display information based on information received by the server from the EMR system and from the RTLS.

### TECHNOLOGY SYSTEM

This application claims the benefit, under 35 U.S.C. §119(e), of U.S. Provisional Application No. 61/770,528, which was filed Feb. 28, 2013, and which is hereby incorporated by reference herein in its entirety.

### BACKGROUND

The present disclosure relates to a healthcare information technology (IT) system and particularly, to a healthcare IT system that displays information regarding patients. More particularly, the present disclosure relates to an electronic room sign for a healthcare IT system.

It is not uncommon in healthcare settings, such as in hospitals and nursing homes, for caregivers to tape handwritten notes and signs on a door of a patient's room or on a wall near the door of a patient's room. The notes and signs oftentimes relate to a patient's medical condition or a contamination risk level associated with a patient. However, these notes and signs are prone to falling down and getting lost. Also, information on the handwritten notes and signs may not be legible and may not be consistent from caregiver to caregiver. Thus, there is a need for improving the manner in which certain types of information, such as information relating to a patient's medical condition and information relating to the patient's contamination risk level, is conveyed to caregivers. Visitors may also appreciate notifications provided to them.

### SUMMARY

An apparatus, system, or method may comprise one or more of the features recited in the appended claims and/or the following features which, alone or in any combination, may comprise patentable subject matter:

An electronic room sign system for use in a healthcare information technology (IT) system that may include an electronic medical records (EMR) system and a real time locating system (RTLS) is provided. The electronic room sign system may include a display that may be mounted adjacent a doorway of a room of a patient. The system may also have a server that may signal the display to display information based on information received by the server from at least one of the EMR system and the RTLS.

In some embodiments, the server may monitor incoming data streams and may map key words to icons that may be shown on the display. The incoming data streams may be processed by the server to determine messages that may include a patient's name or a patient's medical record number of the patient in the room. Alternatively or additionally, the incoming data streams may be processed by the server to determine messages that may include at least one of a room number or a location identification of the room.

According to this disclosure, the display may show a message tailored to a staff member that may be sensed by the RTLS to be in proximity to the display. The information displayed on the display may include, for example, at least one icon specific to a medical condition of a patient in the room. The at least one icon may relates to an allergy of the patient or may relate to the patient being a falls risk. The at least one icon may be an alarm icon relating to an alarm generated by a piece of patient care equipment located in the room. The alarm icon may indicate, for example, that the piece of medical equipment requires attention or that that the patient requires attention.

Further according to this disclosure, the information displayed on the display may include at least one isolation control message. The at least one isolation control message may indicate that staff should take at least one of airborne precautions, contact precautions, containment precautions, droplet precautions, protective precautions, enhanced droplet precautions or contact CD precautions. In some embodiments, the isolation control message may include instructions to staff to do at least one of the following: don gown and gloves before entering the room, don a respirator before entering the room, don a mask before entering the room, close the door upon entry and exit of the room, or sanitize hands before entering the room.

The information displayed on the display also may include issued orders relating to the patient. The issued orders may include, for example, orders regarding an arm of the patient from which blood is not to be drawn.

According to this disclosure, the system may further have additional displays that may be adjacent other doorways of other patient rooms. All of the displays or subsets of the displays may be signaled by the server to display information and messages broadcast by the server to all of the displays. The display may be divided into a first field in which one or more messages for hospital staff are displayed and a second field in which one or more messages for visitors are displayed.

Further according to this disclosure, the display may display information indicating room status. The room status may include, for example, room soiled and awaiting cleaning, room clean, or room occupied. In some embodiments, the display may include user inputs for staff to indicate that the room has been cleaned. The display may display information regarding special post-patient processing that should be undertaken when the room is cleaned.

In some embodiments, the display may display a list of a patient's assigned caregivers and phone extensions of the assigned caregivers. The display may display information indicating that a transport request has been made for the patient. The display may display a list of equipment in the room based on information that may be received by the server from the RTLS.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is an isometric view of a hallway in a healthcare facility showing electronic room signs adjacent doorways of patient rooms and showing, diagrammatically, components of a network of the healthcare facility;

FIG. 2 is a screen shot of one of the electronic room signs showing a contamination risk level field at the top of the screen indicating the types of precautions to be taken by caregivers, icons related to a patient's medical condition in an icon box of a hospital staff field on the left hand side of the screen, and messages in a visitors field on the right hand side of the screen;

FIG. 3 is a screen shot showing lists of the specific precautions to be taken by hospital staff and visitors in connection with the information displayed in the contamination risk level field;

FIGS. 4-6 are screen shots, similar to FIG. 3, showing precaution steps for various types of contamination risk levels;

FIG. 7 is a screen shot showing a hand sanitization reminder message that is displayed on the electronic room sign when no contamination risk level is specified for a patient in the room associated with the electronic room sign;

FIG. 8 is a screen shot, similar to FIG. 2, showing another example of information shown on the electronic room sign and showing the hospital staff field having icons indicating that the associated patient has a latex allergy (hand icon) and is designated as a falls risk (star icon);

FIG. 9 is a screen shot, similar to FIG. 8, showing a pop-up window that appears on the electronic room sign after a staff member touches a cleaning icon on the screen, the pop-up window including a button that is selected to indicate the room has been cleaned;

FIG. 10 is a screen shot, similar to FIG. 8, showing telephone extensions next to staff names displayed at the bottom of the electronic room sign, the telephone extensions appearing after the caregiver name field has been selected; and

FIG. 11 is a screen shot, similar to FIG. 8, showing a heart monitor icon in the hospital staff field to indicate that a heart monitor has an alarm condition that needs attention.

### DETAILED DESCRIPTION

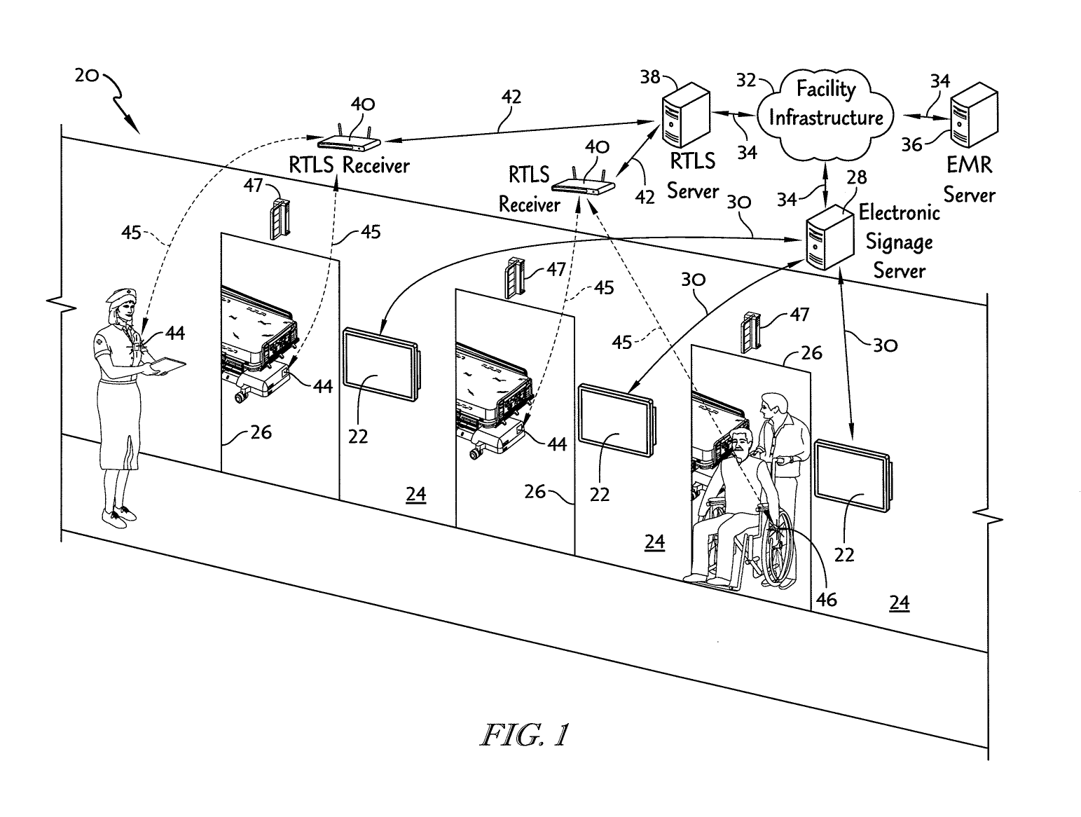

A system 20 includes electronic room signs 22 mounted to a wall 24 adjacent to doorways 26 of a healthcare facility as shown in FIG. 1. In the illustrative example, signs 22 are situated in a hallway outside of the associated patient rooms. Alternatively or additionally, electronic room signs may be located inside the patient rooms. System 20 includes an electronic signage server 28 that is communicatively coupled to each of signs 22 as indicated by diagrammatic arrows 30. Arrows 30 are intended to represent the components, such as wires, cables, routers, gateways, repeaters, etc. that link each of signs 22 to server 28. Signage server 28 is coupled to the computer network of the healthcare facility. In FIG. 1, facility infrastructure 32 is shown diagrammatically and, in connection with diagrammatic arrows 34, is intended to represent the components that interconnect server 28 with other computer devices of system 20 as well as representing the other computer devices themselves. Thus, facility infrastructure 32 is sometimes referred to herein as network 32.

Signage server 28 is programmed with “listening” service software that monitors messages transmitted on the network of the healthcare facility by the various computer devices coupled to the network. The listening service of server 28 identifies messages that relate to patients in the rooms associated with the various signs 22. For example, the listening service identifies a patient's name or medical record number or other patient identification data contained within a message and then analyzes the message for content. Optionally, the listening service identifies a room number or other type of location ID contained with a message and then analyzes the message for content.

In some embodiments of system 20, the listening service of server 28 is configured to process messages in the health level 7 (HL7) format or in the simple object access protocol (SOAP) format. One example of a message the listening service of server 28 may receive and process is as follows: MSH|̂˜\&|MISYS|ME|DADD∥20130111102235∥ORÛR01|20130120000005|T|2.2∥PID|∥700000073∥GENERIĈDAVÊ|̂|19721231|M|̂∥̂∥̂|̂∥∥200000079|32 1569874|∥∥∥∥∥. Another example is as follows: OBX|1|TX|PRECAUTIONŜNO CONTACT|1|̂|NTE|∥Pat: GENERIC,DAVE (700000073) Age/Sex: 36 M Loc: 1104-1 (11FL)NTE|∥. The patient name “Dave Generic” is included as part of each message.

One computer device included in system 20 of the illustrative example is an electronic medical records (EMR) server 36 as shown in FIG. 1. It is within the scope of this disclosure, however, for many other computer devices, such as those included as part of a nurse call system and those included as part of an admission/discharge/transfer (ADT) system, to be coupled to the network of overall system 20. System 20 also includes a real time locating system (RTLS) server 38 which receives location data from RTLS receivers 40 as indicated diagrammatically by arrows 42 in FIG. 1. Receivers 40 receive wireless signals from badges or tags 44 worn by caregivers or attached to equipment to be tracked as indicated by diagrammatic dotted arrows 45 in FIG. 1. Receivers 40 also receive wireless signals from wristbands 46 worn by patients as indicated by an associated diagrammatic arrow 45. Each tag 44 and wristband 46 has identification (ID) data. Each receiver 40 forwards the ID data from tags 44 and wristbands 46 along with its own ID to server 38 which updates a database indicating the location of caregivers and other hospital staff, patients, and equipment within the healthcare facility.

Server 28 receives location messages from server 38 regarding the location of hospital staff, patients, and equipment. Based on the location messages from server 38, server 28 controls signs 22 to display messages and/or icons that are tailored to a particular staff member or patient who are determined to be in the proximity of signs 22. In some embodiments, each sign 22 displays names of staff members present in a patient's room and also displays a list of the pieces of equipment present in a patient's room. In the illustrative example, signs 22 are provided in addition to dome lights 47 of an associated nurse call system of network 32. Dome lights are known in the art. See, for example, U.S. Pat. No. 8,384,536 which is hereby expressly incorporated by reference herein for all that it teaches to the extent not inconsistent with the present disclosure which shall control as to any inconsistencies.

In connection with displaying icons on signs 22, server 28 maps keywords from the incoming data streams to particular icons for display. Thus, each of signs 22 display various characteristics of the respective room, the patient in the respective room, and other information that is intended for caregivers and visitors to see. Server 28 listens to data feeds from the hospital information system (HIS), such as network 32 and servers 36, 38, for any information that is relevant to the rooms, the equipment in the rooms, or the patients in the rooms. If a message containing relevant information about the room, equipment or patient is detected by the listening service of server 28, the listening service determines if the relevant information is mapped to an icon or text that is to be displayed in a particular area of the display. When a match is detected, server 28 updates the associated sign 22 according to the mapping rules.

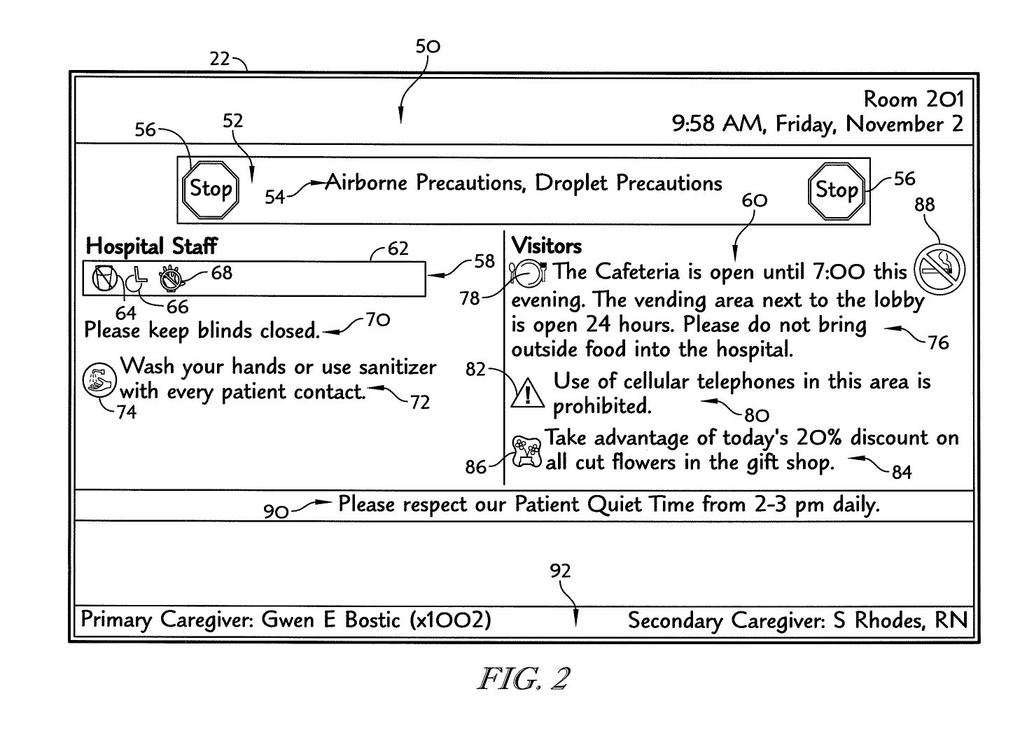

An example of the type of information displayed on signs 22 is shown in FIG. 2. A header area 50 of sign 22 includes the room number associated with the sign 22 as well as showing the date, day, and time. Beneath header 50 is a contamination risk level field 52 that contains an isolation control message 54. In the illustrative example of FIG. 2, the isolation control message is “Airborne Precautions, Droplet Precautions.” Field 52 includes stop sign icons 56 at its opposite end regions in the illustrative example of FIG. 2. Beneath contamination risk level field 52 is a hospital staff field 58 and a visitors field 60. Hospital staff field 58 is on the left half of sign 22 and visitor field 60 is on the right half of sign 22 in the illustrative example.

Hospital staff field 58 includes an icon box 62 in which various icons relating to the associated room, equipment, or patient in the room are displayed. In FIG. 2, a “no liquids” icon 64 indicates that the patient is not currently to be given any liquids to drink, a wheelchair icon 66 indicates that a wheelchair is located in the room, and a latex allergy icon 68 indicates that the patient is allergic to latex. Icons 64, 68 are displayed in box 62 based on information from EMR server 36 and icon 66 is displayed in box 62 based on information from RTLS server 38. Thus, the listening service software of server 28 was able to map messages from servers 36, 38 to icons 64, 66, 68 and then command sign 22 to display icons 64, 66, 68 in box 62.

Hospital staff field 58 also includes a line of text 70 stating, “Please keep blinds closed.” Text 70 is an example of a specific instructional message entered manually by a caregiver at a computer keyboard associated with server 28 for the particular room and patient. Accordingly, it will be appreciated that caregivers can enter whatever messages they wish for display in the same general area in which text 70 appears on sign 22. Field 58 also includes a broadcast message 72 which is sent by server 28 to designated signs 22. For example, a user is able to select with a keyboard and/or display screen that are associated with server 28 whether the broadcast message 72 is displayed on all of signs 22 or just a subset of signs 22 such as those associated with a particular wing or unit of a healthcare facility. In the illustrative example, message 72 states, “Wash hands or use sanitizer with every patient contact” and a handwashing icon 74 is displayed adjacent to message 72.

Visitors field 60 includes multiple broadcast messages and associated icons as shown in FIG. 2. For example, a first broadcast message 76 states, “The cafeteria is open until 7:00 this evening. The vending area next to the lobby is open 24 hours. Please do not bring outside food into the hospital.” A plate and utensil icon 78 is displayed adjacent to message 76. A second broadcast message 80 in field 60 states, “Use of cellular telephones in this area is prohibited” and a triangular warning icon 82 is provided adjacent to message 80. A third broadcast message 84 in field 60 states, “Take advantage of today's 20% discount on all cut flowers in the gift shop” and a flowers icon 86 is provided adjacent to message 84. In the illustrative example of FIG. 2, a “no smoking” icon 88 is also displayed in field 60 and is broadcast without any associated text.

In FIG. 2, a broadcast message 90 is provided on sign 22 and bridges an area beneath both of fields 58, 60. Message 90 states, “Please respect our Patient Quiet Time from 2-3 pm daily” and is intended to be read by hospital staff and visitors. At the bottom of sign 22 is an assigned caregiver field 92 which, in the illustrative example, includes the name of a Primary Caregiver and a Secondary Caregiver. The telephone extension of the Primary Caregiver is also provided in field 92. The information in field 92 is entered manually at server 28 in some embodiments or is determined based on information received by server 28 from network 32 in other embodiments or both.

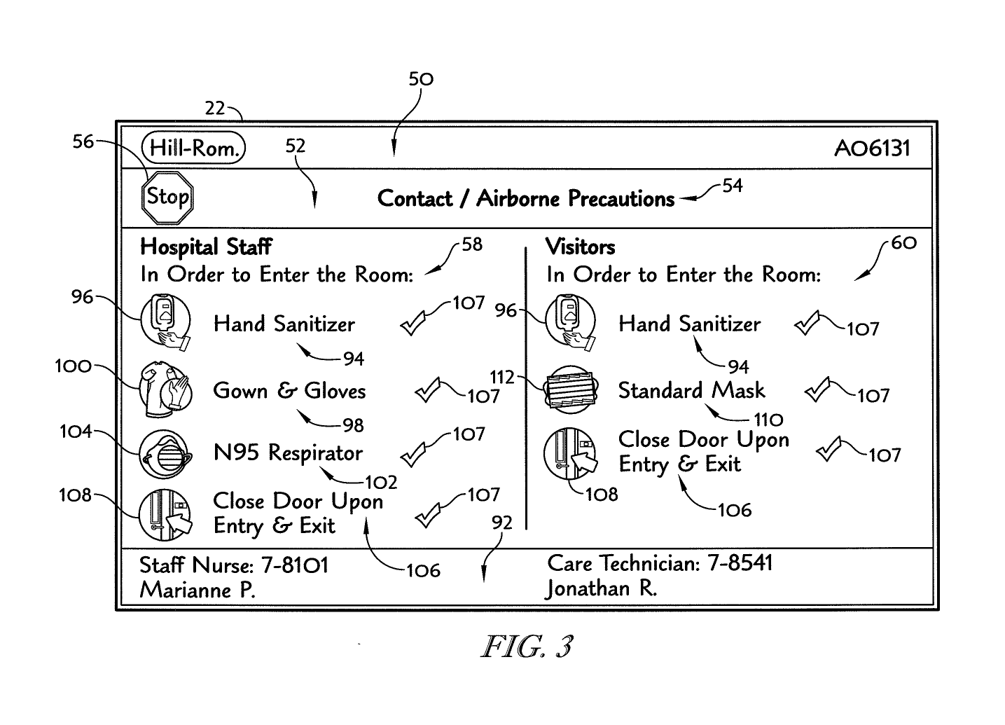

Referring now to FIG. 3, another example of the type of information displayed on signs 22 is shown. Portions of the screen shown in FIG. 3 that are substantially the same as or similar to like portions of the screen shown in FIG. 2, are denoted with like reference numbers. In the example of FIG. 3, more information is shown about the specific precautions that are to be taken by hospital staff and visitors in connection with the isolation control message 54 in contamination risk level field 52. In some embodiments, the screen of FIG. 2 is a home or default screen and the screen of FIG. 3 is an example of a screen that appears after a user touches field 52 to bring up more information about the isolation control message 54. Thus, displays 22 are touch screen displays in such embodiments. Alternatively or additionally, signs 22 may periodically alternate between a screen like that shown in FIG. 2 with field 60 and box 62, for example, and a screen like that shown in FIG. 3 with additional information about precautions. The screens may switch every 10 seconds, for example. Of course periods greater than and less than 10 seconds are within the scope of this disclosure.

In the example of FIG. 3, isolation control message 54 in field 52 states, “Contact/Airborne Precautions.” Under each of the headings “Hospital Staff” and “Visitors” is the introductory text “In Order to Enter the Room:” under which are the specific precautions to be taken. Thus, under the “Hospital Staff” heading the following precautions are listed: “Hand Sanitizer” precaution 94 with accompanying icon 96, “Gown & Gloves” precaution 98 with accompanying icon 100, “N95 Respirator” precaution 102 with accompanying icon 104, and “Close Door Upon Entry & Exit” precaution 106 with accompanying icon 108. Under the “Visitors” heading precautions 94, 106 with their accompanying icons 96, 108 are listed along with a “Standard Mask” precaution 110 and accompanying icon 112. Thus, for some isolation control messages 54, such as the one in the example of FIG. 3, some of the precautions to be taken by hospital staff may be the same as those of visitors and some may differ. A check mark 107 appears to the right of each precaution 94, 98, 102, 106, 110 in the illustrative example to further convey to the reader that they should comply with the listed precaution. In the assigned caregiver field 92 of FIG. 3, the format in which the name of assigned caregivers and their telephone extensions appear is slightly different than that of FIG. 2.

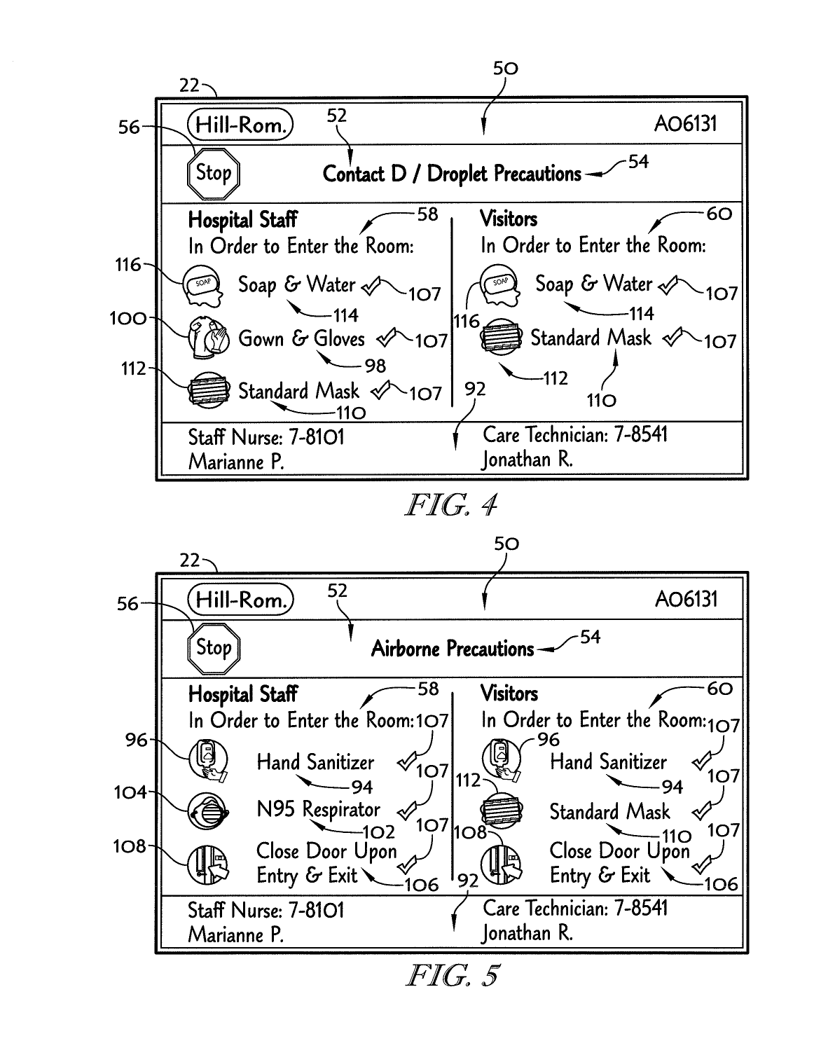

FIGS. 4-6 are screens that are similar to FIG. 3, but that show other examples of isolation control messages 54 in field 52. For example, in FIG. 4, the isolation control message 54 states “Contact D/Droplet Precautions.” In FIG. 4, under the “Hospital Staff” heading and under the “In Order to Enter the Room:” introductory phrase, the following precautions are listed: “Soap & Water” precaution 114 with accompanying icon 116, “Gown & Gloves” precaution 98 and icon 100, and “Standard Mask” precaution 110 and icon 112. Also in FIG. 4, under the “Visitors” heading and under the “In Order to Enter the Room:” introductory phrase, precautions 110, 114 and respective icons 112, 116 are listed.

In the example of FIG. 5 the isolation control message 54 states “Airborne Precautions” and, under the “Hospital Staff” heading and under the “In Order to Enter the Room:” introductory phrase, precautions 94, 102, 106 and respective icons 95, 104, 108 are listed. Also in FIG. 5, under the “Visitors” heading and under the “In Order to Enter the Room:” introductory phrase, precautions 94, 106, 110 and respective icons 96, 108, 112 are listed.

In the example of FIG. 6, the isolation control message 54 states “Contact D Precautions” and, under the “Hospital Staff” heading and under the “In Order to Enter the Room:” introductory phrase, precautions 98, 114 and respective icons 100, 116 are listed. Also in FIG. 6, under the “Visitors” heading and under the “In Order to Enter the Room:” introductory phrase, precaution 114 and associated icon 116 are listed.

In some embodiments, the precautions associated with the contamination risk levels of isolation control messages 54 are those promulgated by organizations such as the Centers for Disease Control (CDC) or World Health Organization (WHO). However, if desired, healthcare facilities may establish precautions more stringent than those recommended by the CDC or WHO. In such cases, the relevant precautions are entered into server 28 with an associated personal computer (e.g., keyboard and display screen) and, if desired, icons for the new or additional precautions are created or designated.

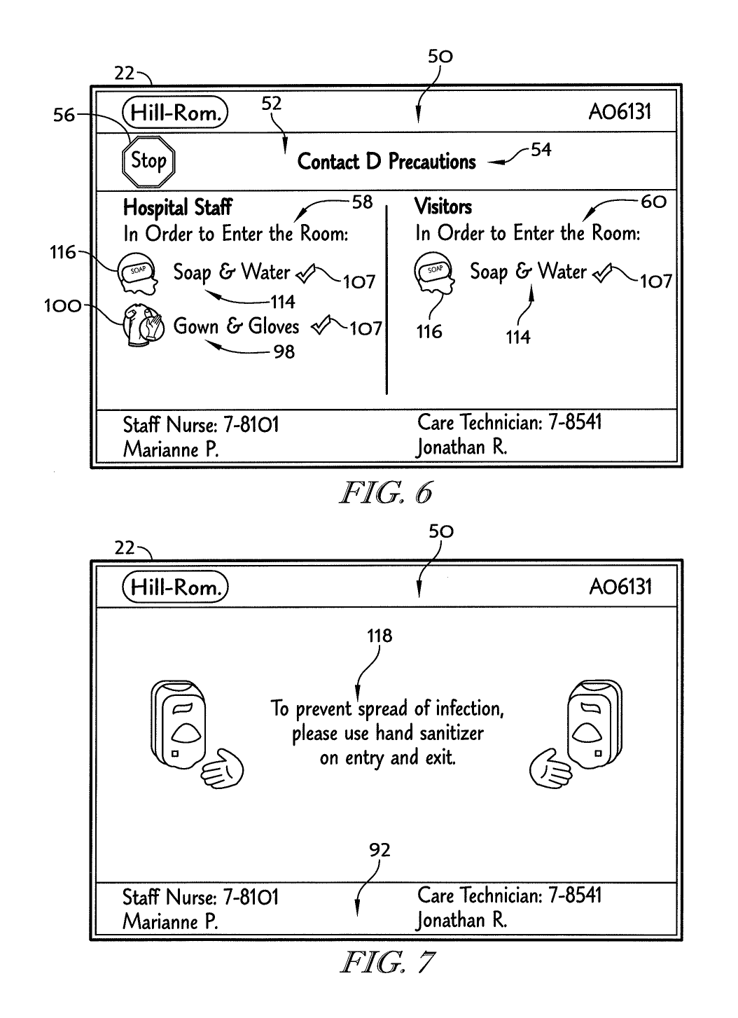

The isolation control message 54 to be displayed in field 52 on signs 22 and the associated precautions and icons to list on signs 22 are determined by server 28 based on data stored in EMR server 36 for each of the patients associated with signs 22. Thus, server 28 maps certain medical conditions of the various patients to certain messages 54. Alternatively or additionally, the EMR server 36 may store the specific isolation control level associated each patient such that server 28 simply reads that control level and selects the precautions and icons to list on signs 22 for the particular patient. If there is no isolation control message 54 to be displayed for any particular patient, then a default handwashing screen, such as the one shown, for example, in FIG. 7, is displayed on the respective sign 22 in some embodiments. In the illustrative example of FIG. 7, a handwashing message 118 on sign 22 states “To prevent spread of infection, please use hand sanitizer on entry and exit” and a pair of hand sanitization icons 120 are shown. In the present disclosure, messages to use hand sanitizer or to use soap and water are both considered to messages to caregivers and visitors to sanitize their hands.

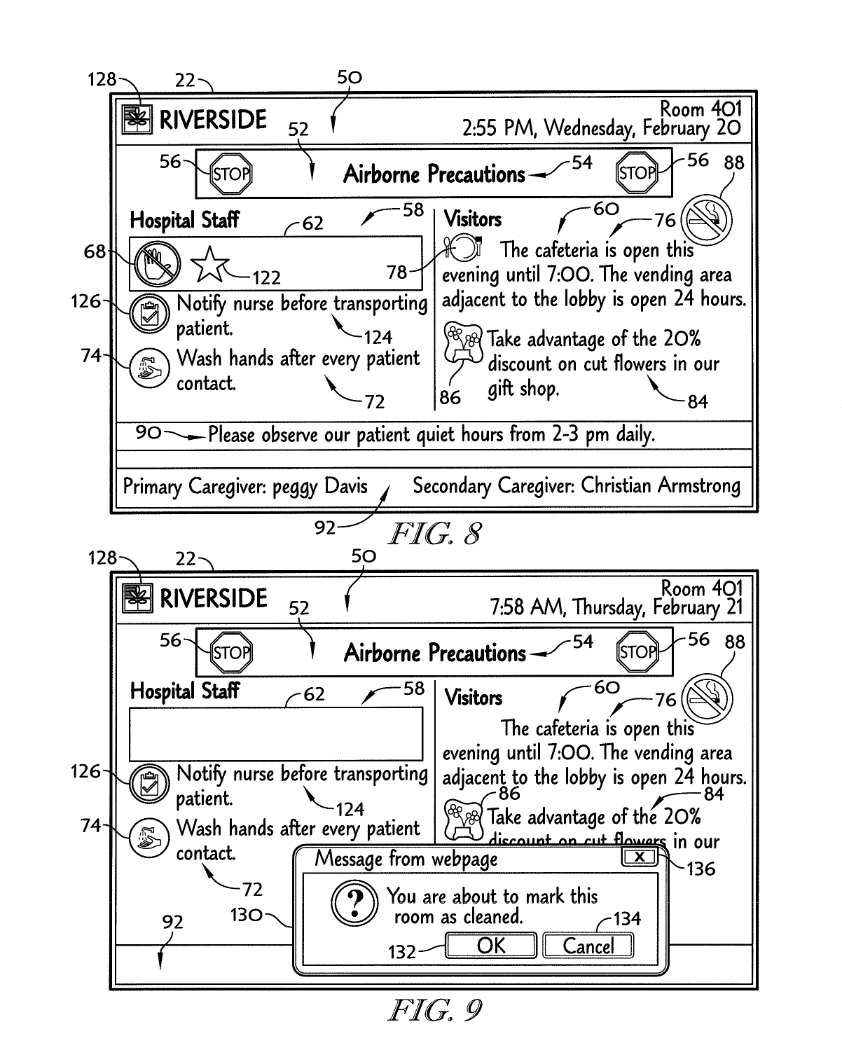

Referring now to FIG. 8, a screen shot that is similar to FIG. 2 and that shows yet another example of the types of information shown on the electronic room signs 22 is provided. Portions of the screen shot of FIG. 8 that are substantially the same as, or substantially similar to, like portions of the screen shot of FIG. 2 are denoted with like reference numerals. In FIG. 8, hospital staff field 62 includes icon 68 indicating that the associated patient has a latex allergy and further has a yellow star icon 122 to indicate that the associated patient is designated as a falls risk. The falls risk designation is determined by server 28 based on information stored in server 36. As compared to FIG. 2, the FIG. 8 screen shot example includes a line of text 124 stating, “Notify nurse before transporting patient” and an associated icon 126 in the hospital staff field 58. Text 124 is another example of a message that is broadcast to one sign or multiple signs. To give another example, the messages in Hospital staff field 58 indicate whether a room is clean, whether the room is occupied, or whether the room is soiled and awaiting cleaning in preparation for the next patient. Furthermore, in assigned caregiver field 92 of the screen shot of FIG. 8, the telephone extensions of the caregivers are omitted from the displayed information.

According to some embodiments, each of signs 22 is used by housekeeping or cleaning staff to indicate that the associated room has been cleaned and is ready for the next patient. Typically, when a patient is discharged or transferred to another location, the hospital's cleaning staff is dispatched to prepare the room for the next patient. The cleaning staff then properly cleans the room before the next patient is permitted to enter the room. This requires coordination between caregivers, transport staff, and the cleaning staff. If a patient is delivered to a room that is not ready for the patient, the patient is sometimes left in the hallway until the room is ready. In other cases, a patient's move to a room that is ready for the patient is delayed because cleaning staff need to travel to a remote location and log into a separate computer to mark the room as cleaned. This can result in backups in the emergency room (ER) or surgical suites because patients cannot be moved to their rooms.

To alleviate these inefficiencies in transferring patients to rooms that are ready for them, sign 22 includes a room clean icon 128 in the upper left corner of sign 22, as shown in FIG. 8, for example, which is selected after the associated room has been cleaned by the cleaning staff. In response to the selection of icon 128, server 28 signals screen 22 to display a pop-up window 130 as shown in FIG. 9. Pop-up window 130 includes the text “You are about to mark this room as cleaned” in the illustrative example of FIG. 9. Window 130 includes an OK button 132 that is selected to indicate the room has been cleaned, a Cancel button 134 that is selected if the cleaning staff does not wish to mark the room as cleaned, and an X button 136 in the upper right corner of window 130 that is selected to close window 130. In response to button 132 being selected in window 130, server 28 commands the associated sign 22 to indicate that the room is ready for the next patient in some embodiments. Alternatively or additionally, in response to button 132 being selected, server 28 sends out a message on the network 32 of the healthcare facility to notify other computer devices, such as an admission, discharge and transfer (ADT) computer, that the room is ready for the next patient.

It is also noteworthy in the screen shot example of FIG. 9 that no icons appear in box 62 because, while the room is being cleaned, there is no patient in the associated room. Also, because there is no patient in the room, there are no assigned hospital staff and hence, field 92 is blank in the screen shot example of FIG. 9. The removal of icons from box 62 and removal of assigned caregiver information from field 92 occurs automatically under control of server 28 based on the data streams processed by server 28 indicating that the patient has been transferred out of the room. However, the broadcast messages still appear in Hospital Staff field 58 in the example of FIG. 9. Thus, in some embodiments, some or all of the broadcast messages still appear on signs 22 even when a patient is not in the associated room. However, in other embodiments, this need not be the case.

In connection with cleaning the patient rooms, some departing patients will have medical conditions that dictate additional steps be taken prior to making the room ready for the next patient. This occurs, for example, in connection with departing patients having the human immunodeficiency virus (HIV) or Methicillin Resistant Staphylococcus Aureus (MRSA) or any other designated highly contagious or dangerous medical condition. In such instances, notes to the cleaning staff can be placed in the hospital staff field 58 at server 28 and designated as “sticky” notes that remain on sign 22 until after the room is marked clean using the OK button 132 of pop-up window 130. Icons and messages that are removed prior to this point are considered “non-sticky” notes according to this disclosure. Thus, the icons in box 62 are examples of non-sticky notes. Other examples of sticky notes that may be included in messages in hospital staff field 58 are requests to remove furniture or return furniture to the patient room during the cleaning process.

While EMR server 36 is shown diagrammatically in FIG. 1, it may be considered to represent all of the computer devices that send data over network 32 which is, in turn, monitored by electronic signage server 28 for data or messages of interest. For example, ADT computers or servers and nurse call computers or servers transmit information over network 32 that is monitored by server 28. Of course, these computers may just as well be considered part of network 32. Thus, in some embodiments, a nurse call computer or server is the computer at which a patient is designated as a falls risk. Therefore, icon 122 of FIG. 8 is displayed on sign 22 based on data from the nurse call computer or server that is received by server 28 in some embodiments. In other embodiments, the falls risk information is obtained from EMR server 38.

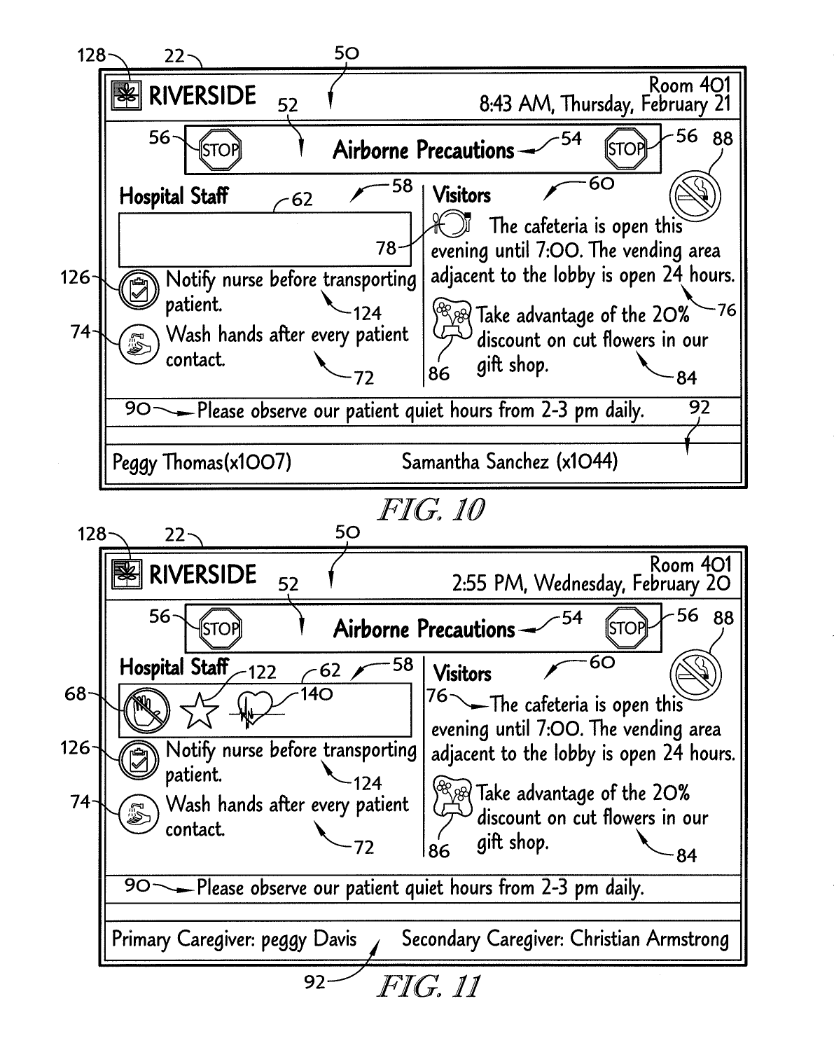

FIG. 10 is a screen shot, similar to FIG. 8, showing telephone extensions next to both staff names in the assigned staff field 92. In some embodiments, the telephone extensions don't appear in field 92 until after the caregiver name field 92, or a particular caregiver name, has been selected by a user by touching sign 22. The remaining features of the screen shot of FIG. 10 have been discussed above in connection with other screens, such as those of FIGS. 2 and 8, and so like reference numerals are used to denote like portions.

Referring now to FIG. 11, a heart monitor icon 140 in the hospital staff box 62 indicates that a heart monitor has an alarm condition that needs attention. The remainder of FIG. 11 is identical to FIG. 8 which was discussed above. Icon 140 represents either a device alarm or a patient alarm. A device alarm indicates that the device needs attention due to a malfunction or due to some other condition such as low battery, for example. A patient alarm indicates that the patient requires attention due to a heart attack or other heart related ailment, for example, sensed by the heart monitor. Thus, as long as the heart monitor device in the room sends messages on network 32, server 28 is able to respond to such device messages by providing device-related alarm icons, such as icon 140, on the associated sign 22. As another example, if a transport request is issued for the patient using a computer device connected to network 32, then server 28 is able to respond to such a transport request message by either placing an appropriate transport request icon in box 62 or placing an appropriate line of text about the transport request beneath box 62. Yet another example is an IV pump alarm transmitted on network 32 resulting in server 28 commanding sign 22 to indicate that an IV alarm, such as a low IV bag, is occurring in the associated room.

Although certain illustrative embodiments have been described in detail above, many embodiments, variations and modifications are possible that are still within the scope and spirit of this disclosure as described herein and as defined in the following claims.

1. An electronic room sign system for use in a healthcare information technology system that includes an electronic medical records (EMR) system and a real time locating system (RTLS), the electronic room sign system comprising
a display mounted adjacent a doorway of a room of a patient, and
a server signaling the display to display information based on information received by the server from at least one of the EMR system and the RTLS.

2. The electronic room sign system of claim 1, wherein the server monitors incoming data streams and maps key words to icons that are to be shown on the display.

3. The electronic room sign system of claim 2, wherein the incoming data streams are processed by the server to determine messages including at least one of a patient's name or a patient's medical record number of the patient in the room.

4. The electronic room sign system of claim 2, wherein the incoming data streams are processed by the server to determine messages including at least one of a room number or a location identification of the room.

5. The electronic room sign system of claim 2, wherein the display shows a message tailored to a staff member sensed by the RTLS to be in proximity to the display.

6. The electronic room sign system of claim 1, wherein the information displayed on the display includes at least one icon specific to a medical condition of a patient in the room.

7. The electronic room sign system of claim 6, wherein the at least one icon relates to an allergy of the patient.

8. The electronic room sign system of claim 6, wherein the at least one icon relates to the patient being a falls risk.

9. The electronic room sign system of claim 6, wherein the at least one icon is an alarm icon relating to an alarm generated by a piece of patient care equipment located in the room.

10. The electronic room sign system of claim 9, wherein the alarm icon indicates that the piece of medical equipment requires attention.

11. The electronic room sign system of claim 9, wherein the alarm icon indicates that the patient requires attention.

12. The electronic room sign system of claim 1, wherein the information displayed on the display includes at least one isolation control message.

13. The electronic room sign system of claim 12, wherein the at least one isolation control message indicates that staff should take at least one of airborne precautions, contact precautions, containment precautions, droplet precautions, protective precautions, enhanced droplet precautions or contact CD precautions.

14. The electronic sign system of claim 12, wherein the isolation control message includes instructions to staff to do at least one of the following: don gown and gloves before entering the room, don a respirator before entering the room, don a mask before entering the room, close the door upon entry and exit of the room, sanitize hands before entering the room.

15. The electronic sign system of claim 1, wherein the information displayed on the display includes issued orders relating to the patient.

16. The electronic sign system of claim 15, wherein the issued orders include orders regarding an arm of the patient from which blood is not to be drawn.

17. The electronic sign system of claim 1, further comprising additional displays that are adjacent other doorways of other patient rooms and that are signaled by the server to display information and wherein each of the displays includes a general information field which displays messages broadcast by the server to all of the displays.

18. The electronic sign system of claim 1, wherein the display is divided into a first field in which one or more messages for hospital staff are displayed and a second field in which one or more messages for visitors are displayed.

19. The electronic sign system of claim 1, wherein the display displays information indicating room status.

20. The electronic sign system of claim 19, wherein the room status includes at least one of room soiled and awaiting cleaning, room clean, or room occupied.

21. The electronic sign system of claim 1, wherein the display includes user inputs for staff to indicate that the room has been cleaned.

22. The electronic sign system of claim 21, wherein the display displays information regarding special post-patient processing that should be undertaken when the room is cleaned.

23. The electronic sign system of claim 1, wherein the display displays a list of a patient's assigned caregivers and phone extensions of the assigned caregivers.

24. The electronic sign system of claim 1, wherein the display displays information indicating that a transport request has been made for the patient.

25. The electronic sign system of claim 1, wherein the display displays a list of equipment in the room based on information received by the server from the RTLS.
